(19) United States
(12) Patent Application Publication
(10) Pub. No.: US 2020/0272175 A1
(43) Pub. Date: Aug. 27, 2020

(54) AERIAL VEHICLE CONTROL METHOD AND APPARATUS

(71) Applicant: AUTEL ROBOTICS CO., LTD., Shenzhen (CN)

(72) Inventor: Fengan Zhou, Shenzhen (CN)

(21) Appl. No.: 16/874,193

(22) Filed: May 14, 2020

Related U.S. Application Data
(63) Continuation of application No. PCT/CN2018/106553, filed on Sep. 19, 2018.

(30) Foreign Application Priority Data
Nov. 14, 2017 (CN) 2017111244003

(51) Int. Cl. G05D 1/10; G05D 1/00; B64C 39/02; G06F 21/44

(52) U.S. Cl. CPC G05D 1/101; G05D 1/0022; G06Q 10/1093; G06F 21/44; B64C 2201/146; B64C 39/024

(57) ABSTRACT

Embodiments of the present application disclose an aerial vehicle control method and apparatus. The method includes: receiving, by a first device, a control instruction from a second device; determining, by the first device, whether the second device has permission to send the control instruction; and if yes, sending, by the first device, the control instruction to an aerial vehicle to control the aerial vehicle to perform an operation corresponding to the control instruction. According to the above solutions, the first device may receive the control instruction sent by the second device, and send the control instruction to the aerial vehicle to control the aerial vehicle after determining the permission, thereby reducing complexity in controlling the first device by a user.

### RELATED APPLICATIONS

This application is a continuation application of International Application No. PCT/CN2018/106553, filed on Sep. 19, 2018, which claims priority of Chinese Patent Application No. 201711124400.3, filed on Nov. 14, 2017, which is incorporated herein by reference in its entirely.

### BACKGROUND

### Technical Field

The present application relates to aerial vehicle technologies, and in particular, to an aerial vehicle control method and apparatus.

### Related Art

Currently, with the development of unmanned aerial vehicle (UAV) technologies, a UAV can communicate with a device after being connected to the device. The device may be a remote control or a user terminal. The UAV may be referred to as an aerial vehicle for short herein. When the aerial vehicle is connected to the user terminal, a user may control, through the user terminal, the aerial vehicle to perform operations such as flying or taking photographs. Since the aerial vehicle can implement increasing functions, complexity in controlling the aerial vehicle increases. Reducing the complexity in controlling the aerial vehicle becomes a subject actively studied by those skilled in the art of the present application.

### SUMMARY

Embodiments of the present application provide an aerial vehicle control method and apparatus, to implement controlling of an aerial vehicle by a plurality of devices, thereby reducing complexity in controlling the aerial vehicle.

According to a first aspect, an embodiment of the present application provides an aerial vehicle control method, including:

receiving, by a first device, a control instruction from a second device;

determining, by the first device, whether the second device has permission to send the control instruction; and

if yes, sending, by the first device, the control instruction to an aerial vehicle to control the aerial vehicle to perform an operation corresponding to the control instruction.

Optionally, before the receiving, by a first device, a control instruction from a second device, the method further includes:

receiving, by the first device, a control request of the second device, the control request being used for requesting to control the aerial vehicle; and

assigning, by the first device to the second device according to the control request, permission to control the aerial vehicle.

Optionally, before the receiving, by a first device, a control instruction from a second device, the method further includes:

assigning, by the first device to at least one device connected to the first device, permission to control the aerial vehicle.

Optionally, the method further includes:

sending, by the first device, information about the assigned permission to a corresponding device.

Optionally, the determining, by the first device, whether the second device has permission to send the control instruction includes:

determining, by the first device, a control function corresponding to the control instruction;

determining, by the first device, whether the second device has permission corresponding to the control function; and

if yes, determining, by the first device, that the second device has the permission to send the control instruction.

Optionally, the determining, by the first device, whether the second device has permission to send the control instruction includes:

determining, by the first device, a time at which the second device sends the control instruction;

determining, by the first device, whether the sending time meets permission possessed by the second device; and

if yes, determining, by the first device, that the second device has the permission to send the control instruction.

Optionally, the determining, by the first device, whether the second device has permission to send the control instruction includes:

obtaining, by the first device, position information of the second device;

determining, by the first device, whether the position information of the second device meets permission possessed by the second device; and

if yes, determining, by the first device, that the second device has the permission to send the control instruction.

According to a second aspect, an embodiment of the present application provides a device, including:

a receiving module configured to receive a control instruction from a second device;

a determining module configured to determine whether the second device has permission to send the control instruction, and send a determining result to a sending module; and

the sending module configured to: when the determining result is that the second device has the permission to send the control instruction, send the control instruction to an aerial vehicle to control the aerial vehicle to perform an operation corresponding to the control instruction.

Optionally, the receiving module is further configured to:

receive a control request from the second device, the control request being used for requesting to control the aerial vehicle.

The device further includes:

an assigning module configured to assign, to the second device according to the control request, permission to control the aerial vehicle.

Optionally, the device further includes:

an assigning module configured to assign, to at least one device connected to the first device, permission to control the aerial vehicle.

Optionally, the sending module is further configured to:

send information about the assigned permission to a corresponding device.

Optionally, the determining module is specifically configured to implement the determining whether the second device has permission to send the control instruction in the following manner:

determining a control function corresponding to the control instruction;

determining whether the second device has permission corresponding to the control function; and

if yes, determining that the second device has the permission to send the control instruction.

Optionally, the determining module is specifically configured to implement the determining whether the second device has permission to send the control instruction in the following manner:

determining a time at which the second device sends the control instruction;

determining whether the sending time meets permission possessed by the second device; and

if yes, determining that the second device has the permission to send the control instruction.

Optionally, the determining module is specifically configured to implement the determining whether the second device has permission to send the control instruction in the following manner:

obtaining position information of the second device;

determining whether the position information of the second device meets permission possessed by the second device; and

if yes, determining that the second device has the permission to send the control instruction.

According to a third aspect, an embodiment of the present application provides a device, including a processor and a computer readable storage medium, the computer readable storage medium storing a computer instruction, and the processor being configured to invoke the computer instruction to perform the aerial vehicle control method according to any of the above.

According to a fourth aspect, an embodiment of the present application provides a computer readable storage medium storing a computer program, when the computer program is executed by a processor, steps of the aerial vehicle control method according to any of the above are implemented.

In the embodiments of the present application, the first device receives the control instruction from the second device; the first device determines whether the second device has the permission to send the control instruction; and if yes, the first device sends the control instruction to the aerial vehicle to control the aerial vehicle to perform the operation corresponding to the control instruction. According to the above solutions, the first device may receive the control instruction sent by the second device, and send the control instruction to the aerial vehicle to control the aerial vehicle after determining the permission, thereby reducing complexity in controlling the first device by a user.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a flowchart of an aerial vehicle control method according to a first embodiment of the present application.

FIG. 2 is a flowchart of an aerial vehicle control method according to a second embodiment of the present application.

FIG. 3 is a flowchart of an aerial vehicle control method according to a third embodiment of the present application.

FIG. 4 is a schematic structural composition diagram of a device according to an embodiment of the present application.

FIG. 5 is a schematic structural composition diagram of another device according to an embodiment of the present application.

### DETAILED DESCRIPTION

The following describes the embodiments of the present application in detail with reference to the accompanying drawings. It should be noted that the embodiments in the present application and features in the embodiments can be combined with each other in the case of no conflict.

The steps shown in the flowcharts in the accompanying drawings of the present application may be performed in, for example, a computer system having a set of computer executable instructions. In addition, although a logical sequence is shown in a flowchart, the shown or described steps may be performed in a different sequence in some cases.

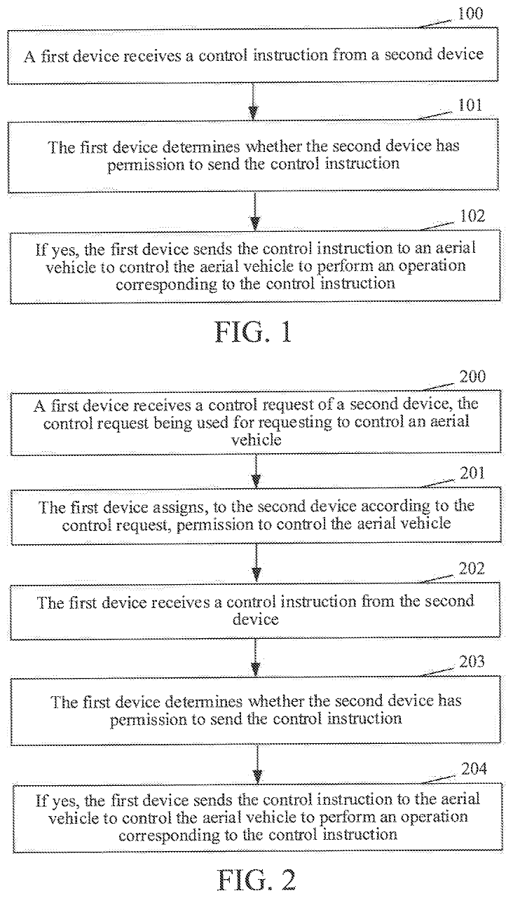

Referring to FIG. 1, a first embodiment of the present application provides an aerial vehicle control method, including the following steps.

Step 100: A first device receives a control instruction from a second device.

In an implementation, before the first device receives the control instruction from the second device, the first device may be connected to the second device in a wired or wireless manner. If to be connected in a wireless manner, the first device and the second device are may be connected through Wireless Fidelity (Wi-Fi) or Bluetooth.

The first device may be a device that is to establish a connection to an aerial vehicle. For example, the first device may be a user terminal or a remote controller for remotely controlling the aerial vehicle. No limitation is imposed herein. The second device may receive a user operation and may generate a control instruction according to the user operation and send the control instruction to the first device. For example, the second device may be a user terminal, and the user terminal may include any of a personal computer (PC), a smart phone, a wearable terminal, a virtual reality (VR) terminal, and an image display terminal, etc.

The control instruction sent by the second device may be used for controlling the aerial vehicle to perform an operation corresponding to the control instruction. For example, the aerial vehicle is controlled to perform a flight operation, perform a photographing operation, perform a video recording operation, or perform a measurement operation, etc.

Step 101: The first device determines whether the second device has permission to send the control instruction.

Optionally, the first device may determine whether the second device has the permission to send the control instruction in any of the following manners.

In the first manner, the first device determines a control function corresponding to the control instruction.

The first device determines whether the second device has permission corresponding to the control function.

If yes, the first device determines that the second device has the permission to send the control instruction. If not, the first device determines that the second device has no permission to send the control instruction.

The control instruction may be used for controlling the aerial vehicle to implement a specific function, for example, controlling the aerial vehicle to implement a flight function, controlling the aerial vehicle to implement a photographing function, etc. Further, if the control instruction is used for controlling the aerial vehicle to implement a flight function, the control instruction may be used for controlling a flight status, a flight mode, a flight path, etc. of the aerial vehicle, so as to control the aerial vehicle to implement the corresponding flight function.

Exemplarily, the first device may assign permission to the second device based on the control function. Certainly, the first device may assign permission of one or more control functions to the second device, that is, the second device has the permission to control the one or more control functions. No limitation is imposed herein.

The first device may assign the same permission or different permission to a plurality of devices. If the same permission is assigned, different devices may control the aerial vehicle through the first device to implement one or more control functions. If different permission is assigned, different devices may control different functions of the aerial vehicle. For example, a control instruction of a device can be used for controlling only the flight function of the aerial vehicle, for example, controlling the flight mode of the aerial vehicle, and a control instruction of another device can be used for controlling only the photographing function of the aerial vehicle.

In an implementation, the first device may establish a correspondence between a control function and a device and store the correspondence. If there is a correspondence between one device and one or more control functions, it indicates that the device has the permission to send control instructions corresponding to the one or more control functions. Optionally, the device in the above correspondence may be represented by using a device identifier of the device.

After the first device receives the control instruction of the second device, the first device may recognize the control instruction of the second device, and then determine a control function to be controlled by using the control instruction.

Specifically, the first device may determine the control function corresponding to the control instruction according to a preset first correspondence between a control instruction and a control function. In other words, the first device searches the first correspondence for the control function corresponding to the control instruction, so as to determine the control function corresponding to the control instruction.

In an implementation, the first device may determine, according to a pre-established second correspondence between a control function and the device, whether the second device has the permission corresponding to the control function. In other words, the first device searches the second correspondence to determine whether there is a correspondence between the control function corresponding to the control instruction and the second device. When there is a correspondence between the control function corresponding to the control instruction and the second device, it is determined that the second device has the permission corresponding to the control function. When there is no correspondence between the control function corresponding to the control instruction and the second device, it is determined that the second device has no permission corresponding to the control function.

In the second manner, the first device determines a time at which the second device sends the control instruction.

The first device determines whether the sending time meets permission possessed by the second device.

If yes, the first device determines that the second device has the permission to send the control instruction. If not, the first device determines that the second device has no permission to send the control instruction.

Exemplarily, the first device may assign permission to the second device based on the sending time. Certainly, the first device may assign permission of one or more sending time periods to the second device, that is, the second device has the permission to control the aerial vehicle within one or more time periods. No limitation is imposed herein.

The first device may assign the same permission or different permission to a plurality of devices. If the same permission is assigned, different devices may respectively control the aerial vehicle through the first device within the same sending time period. If different permission is assigned, different devices may control the aerial vehicle within different sending time periods. For example, a control instruction of a device may be used for controlling the aerial vehicle during only a first sending time period, for example, controlling the aerial vehicle from 9 am to 10 am every day, and a control instruction of another device may be used for controlling the aerial vehicle during only a second sending time period, for example, controlling the aerial vehicle from 2 pm to 3 pm every day.

In an implementation, the first device may establish a correspondence between a sending time period and a device and store the correspondence. If there is a correspondence between one device and one or more sending time periods, it indicates that the device has the permission to send a control instruction within the one or more sending time periods. Optionally, the device in the above correspondence may be represented by using a device identifier of the device.

After the first device receives the control instruction of the second device, the first device may recognize the control instruction of the second device, and then determine the time at which the control instruction is sent.

Specifically, the first device may determine, as the time at which the second device sends the control instruction, a time at which the control instruction is received. Alternatively, the first device may determine, according to information carried in the control instruction, the time at which the control instruction is sent. Alternatively, after receiving the control instruction, the first device may send, to the second device, a request to obtain the sending time, so as to obtain the sending time at which the second device sends the control instruction. Certainly, the first device may also determine, in other manners, the time at which the second device sends the control instruction. No limitation is imposed in this embodiment of the present application.

In an implementation, the first device may determine, according to a pre-established third correspondence between a sending time period and a device, whether the sending time meets the permission possessed by the second device. In other words, the first device searches the third correspondence to determine whether there is a correspondence between the time at which the control instruction is sent and the second device. When there is a correspondence between the time at which the control instruction is sent and the second device, it is determined that the sending time meets the permission possessed by the second device. When there is no correspondence between the time at which the control instruction is sent and the second device, it is determined that the sending time does not meet the permission possessed by the second device.

In the third manner, the first device obtains position information of the second device.

The first device determines whether the position information of the second device meets permission possessed by the second device.

If yes, the first device determines that the second device has the permission to send the control instruction. If not, the first device determines that the second device has no permission to send the control instruction.

Exemplarily, the first device may assign permission to the second device based on the position information of the second device. Certainly, the first device may assign permission of one or more areas to the second device, that is, the second device has the permission to control the aerial vehicle within one or more areas. No limitation is imposed herein.

The first device may assign the same permission or different permission to a plurality of devices. If the same permission is assigned, different devices may respectively control the aerial vehicle through the first device within the same area. If different permission is assigned, different devices may control the aerial vehicle within different areas. For example, a control instruction of a device may be used for controlling the aerial vehicle within only a first area, for example, controlling the aerial vehicle in Beijing areas, and a control instruction of another device may be used for controlling the aerial vehicle within only a second area, for example, controlling the aerial vehicle within Tianjin areas.

In an implementation, the first device may establish a correspondence between an area and a device and store the correspondence. If there is a correspondence between one device and one or more areas, it indicates that the device has the permission to send a control instruction within the one or more areas. Optionally, the device in the above correspondence may be represented by using a device identifier of the device.

After the first device receives the control instruction of the second device, the first device may recognize the control instruction of the second device, and then determine the position information of the control instruction.

Specifically, the first device may determine, according to information carried in the control instruction, the position information of the control instruction. Alternatively, after receiving the control instruction, the first device may send, to the second device, a request to obtain the position information, so as to obtain the position information of the second device. Certainly, the first device may also determine the position information of the second device in other manners. No limitation is imposed in this embodiment of the present application.

In an implementation, the first device may determine, according to a pre-established fourth correspondence between an area and a device, whether the position information of the second device meets the permission possessed by the second device. In other words, the first device searches the fourth correspondence to determine whether there is a correspondence between the position information of the second device and the second device. When there is a correspondence between the position information of the second device and the second device, it is determined that the position information of the second device meets the permission possessed by the second device. When there is no correspondence between the position information of the second device and the second device, it is determined that the position information of the second device does not meet the permission possessed by the second device.

Certainly, the above combination method is merely an example, and other combination methods are not limited herein.

Step 102: If yes, the first device sends the control instruction to the aerial vehicle to control the aerial vehicle to perform an operation corresponding to the control instruction.

In step 101, if the first device determines that the second device has the permission to send the control instruction, the first device may send the control instruction to the aerial vehicle. Through the first device, control on the aerial vehicle by other devices can be managed, so that the permission for controlling the aerial vehicle can be assigned to each device, thereby reducing complexity of controlling the aerial vehicle by one device.

In step 101, if the first device determines that the second device does not have the permission to send the control instruction, the first device may notify the second device or ask the user whether to open the permission of the second device. No limitation is imposed herein.

Optionally, the method further includes:

after the aerial vehicle performs the corresponding operation according to the control instruction, the first device may further receive information fed back by the aerial vehicle for the operation, for example, flight parameter information, flight status information, a captured video or image, etc. The first device may send the received feedback information to the second device. The second device performs operations such as storage, displaying, and processing, etc. No limitation is imposed herein.

According to the above solutions, the first device may receive the control instruction sent by the second device, and send the control instruction to the aerial vehicle to control the aerial vehicle after determining the permission, thereby reducing complexity in controlling the first device by a user.

Referring to FIG. 2, a second embodiment of the present application provides an aerial vehicle control method, including the following steps.

Step 200: The first device receives a control request of the second device, the control request being used for requesting to control the aerial vehicle.

Step 201: The first device assigns, to the second device according to the control request, permission to control the aerial vehicle.

The first device may assign permission according to the control request in any of the following manners.

In the first manner, when the control request is used for requesting one or more control functions, the first device may assign permission corresponding to the one or more control functions to the second device according to the control request. Specifically, the first device may establish a correspondence between the one or more control functions and the second device. The correspondence may be used for indicating that the second device has permission to control the one or more control functions.

In the second manner, when the control request is used for requesting to control the aerial vehicle within one or more time periods, the first device may assign, to the second device according to the control request, permission for the second device to control the aerial vehicle within the one or more time periods. Specifically, the first device may establish a correspondence between the one or more time periods and the second device. The correspondence may be used for indicating that the second device has the permission to control the aerial vehicle within the one or more time periods.

In the third manner, when the control request is used for requesting to control the aerial vehicle within one or more areas, the first device may assign, to the second device according to the control request, permission for the second device to control the aerial vehicle within the one or more areas. Specifically, the second device may establish a correspondence between the one or more areas and the second device. The correspondence may be used for indicating that the second device has the permission to control the aerial vehicle within the one or more areas.

Optionally, before the first device assigns the corresponding permission to the second device according to the control request, the first device may determine, according to the control request, whether the corresponding permission is assigned to other devices. If the permission is assigned to other devices, it may be further determined whether one permission can be assigned to a plurality of devices. If it is determined that one permission cannot be assigned to a plurality of devices, the first device may send rejection information to the second device. The rejection information is used for indicating that the permission corresponding to the control request is assigned. In the above manner, if the first device determines that the corresponding permission is not assigned to other devices, or determines that one permission can be assigned to a plurality of devices, the first device may send confirmation information to the second device. The confirmation information indicates that the second device possesses the requested permission.

Step 202: The first device receives a control instruction from the second device.

Step 203: The first device determines whether the second device has permission to send the control instruction.

Step 204: If yes, the first device sends the control instruction to the aerial vehicle to control the aerial vehicle to perform an operation corresponding to the control instruction.

For a specific implementation process of steps 202 to 204, reference may be made to the specific implementation process of steps 100 to 102, and details are not be repeated herein.

According to the above solution, the first device may receive the control request of the second device, to assign, to the second device, the permission to control the aerial vehicle. In addition, the first device may receive the control instruction sent by the second device, and send the control instruction to the aerial vehicle to control the aerial vehicle after determining the permission, thereby reducing complexity in controlling the first device by a user.

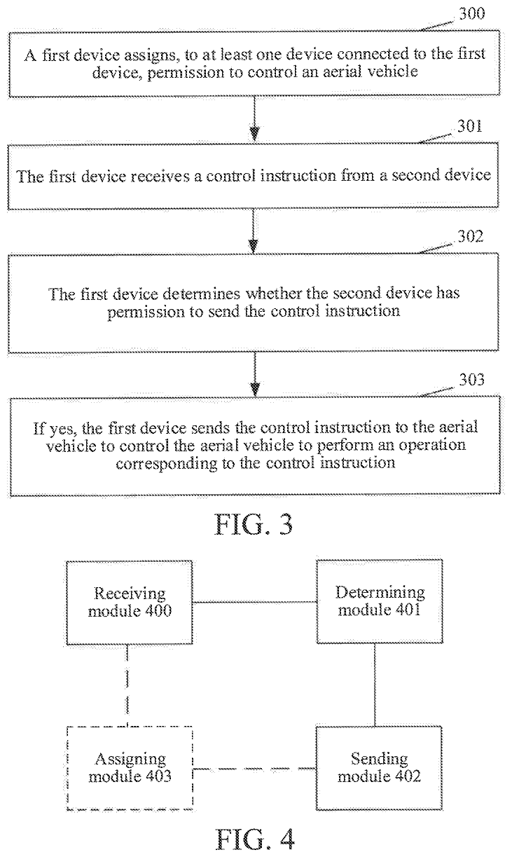

Referring to FIG. 3, a third embodiment of the present application provides an aerial vehicle control method, including the following steps.

Step 300: The first device assigns, to at least one device connected to the first device, permission to control the aerial vehicle.

In an implementation, the first device may be connected to at least one device. Specifically, the first device may broadcast scan information, and determine that the second device is connected to the first device when receiving a response message from the second device for the scan information. The scan information may be any information, and the response message may be any message.

In an implementation, the first device may assign, to the at least one device according to a control function, a time period, an area in which a device is located, or a combination of any two or three of the above methods, the permission to control the aerial vehicle. A specific assigning manner is not limited in the present application.

Optionally, the first device may further send information about the assigned permission to a corresponding device.

The permission information is used for indicating the permission possessed by the second device. For example, the information about the permission is used for indicating that the second device has permission of one or more control functions. Alternatively, the information about the permission is used for indicating that the second device has permission to control the aerial vehicle within one or more time periods. Alternatively, the information about the permission is used for indicating that the second device has permission to control the aerial vehicle within one or more areas, etc. The information about the permission is not limited herein.

Step 301: The first device receives a control instruction from the second device.

Step 302: The first device determines whether the second device has permission to send the control instruction.

Step 303: If yes, the first device sends the control instruction to the aerial vehicle to control the aerial vehicle to perform an operation corresponding to the control instruction.

For a specific implementation process of steps 301 to 303, reference may be made to the specific implementation process of steps 100 to 102, and details are not be repeated herein.

Optionally, when the first device determines that the second device does not have the permission to send the control instruction, the process ends.

According to the above solutions, the first device may assign, to the at least one device connected to the first device, the permission to control the aerial vehicle, and may receive the control instruction sent by the second device, and send the control instruction to the aerial vehicle to control the aerial vehicle after determining the permission, thereby reducing complexity in controlling the first device by a user.

Referring to FIG. 4, a fourth embodiment of the present application provides a device, including:

a receiving module 400 configured to receive a control instruction from a second device;

a determining module 401 configured to determine whether the second device has permission to send the control instruction, and send a determining result to a sending module; and

the sending module 402 configured to: when the determining result is that the second device has the permission to send the control instruction, send the control instruction to an aerial vehicle to control the aerial vehicle to perform an operation corresponding to the control instruction.

Optionally, the receiving module 400 is further configured to:

receive a control request from the second device, the control request being used for requesting to control the aerial vehicle.

The device further includes:

an assigning module 403 configured to assign, to the second device according to the control request, permission to control the aerial vehicle.

Optionally, the device further includes:

an assigning module 403 configured to assign, to at least one device connected to the first device, permission to control the aerial vehicle.

Optionally, the sending module 402 is further configured to:

send information about the assigned permission to a corresponding second device.

Optionally, the determining module 401 is specifically configured to implement the determining whether the second device has permission to send the control instruction in the following manner:

determining a control function corresponding to the control instruction;

determining whether the second device has permission corresponding to the control function; and

if yes, determining that the second device has the permission to send the control instruction.

Optionally, the determining module 401 is specifically configured to implement the determining whether the second device has permission to send the control instruction in the following manner:

determining a time at which the second device sends the control instruction;

determining whether the sending time meets permission possessed by the second device; and

if yes, determining that the second device has the permission to send the control instruction.

Optionally, the determining module 401 is specifically configured to implement the determining whether the second device has permission to send the control instruction in the following manner:

obtaining position information of the second device;

determining whether the position information of the second device meets permission possessed by the second device; and

if yes, determining that the second device has the permission to send the control instruction.

The above functional modules may be implemented by software, or by hardware, or a combination of the above two methods. No limitation is imposed herein.

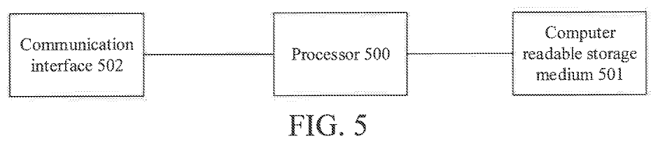

Referring to FIG. 5, a fifth embodiment of the present application further provides a device, including a processor 500 and a computer readable storage medium 501. The computer readable storage medium 501 stores a computer instruction, and the processor 500 invokes the computer instruction to perform any of the above aerial vehicle control methods. For example, the processor 500 invokes the computer instruction to perform the following steps:

receiving a control instruction from a second device;

determining whether the second device has permission to send the control instruction; and

if yes, sending the control instruction to an aerial vehicle to control the aerial vehicle to perform an operation corresponding to the control instruction.

The computer-readable storage medium 501 includes at least one of the following: a flash memory, a hard disk, a multimedia card, a card type memory (such as a secure digital memory card or a data register memory), a random access memory (RAM), a static random access memory (SRAM), a read only memory (ROM), an electrically erasable programmable read only memory (EEPROM), a programmable read only memory (PROM), a magnetic memory, a magnetic disk, an optical disc, and the like.

The processor 500 may include one or more of a central processing unit (CPU), a controller, a microcontroller, a microprocessor, or another data processing chip.

The foregoing device further includes a communications interface 502 for receiving and sending information such as a control instruction, a control request, and information about assigned rights.

The computer-readable storage medium 501 may further store the foregoing correspondence.

An embodiment of the present application further provides a computer-readable storage medium on which a computer program is stored, and the computer program, when executed by a processor, implements the steps in the foregoing aerial vehicle control method.

Although the embodiments of the present application are disclosed above, the content described is only the embodiments adopted to facilitate the understanding of the present application, and is not intended to limit the present application. Any person skilled in the art to which the present application belongs may make any modification and change in the form and details of implementation without departing from the spirit and scope of the present application, but the patent protection scope of the present application shall be still subject to the appended claims.

What is claimed is:

1. An aerial vehicle control method, comprising:
receiving, by a first device, a control instruction from a second device;
determining, by the first device, whether the second device has permission to send the control instruction; and
if yes, sending, by the first device, the control instruction to an aerial vehicle to control the aerial vehicle to perform an operation corresponding to the control instruction.

2. The method according to claim 1, wherein before the receiving, by a first device, a control instruction from a second device, the method further comprises:
receiving, by the first device, a control request of the second device, the control request being used for requesting to control the aerial vehicle; and
assigning, by the first device to the second device according to the control request, permission to control the aerial vehicle.

3. The method according to claim 1, wherein before the receiving, by a first device, a control instruction from a second device, the method further comprises:
assigning, by the first device to at least one device connected to the first device, permission to control the aerial vehicle.

4. The method according to claim 3, further comprising:
sending, by the first device, information about the assigned permission to a corresponding device.

5. The method according to claim 1, wherein the determining, by the first device, whether the second device has permission to send the control instruction comprises:
determining, by the first device, a control function corresponding to the control instruction;
determining, by the first device, whether the second device has permission corresponding to the control function; and
if yes, determining, by the first device, that the second device has the permission to send the control instruction.

6. The method according to claim 1, wherein the determining, by the first device, whether the second device has permission to send the control instruction comprises:
determining, by the first device, a time at which the second device sends the control instruction;
determining, by the first device, whether the sending time meets permission possessed by the second device; and
if yes, determining, by the first device, that the second device has the permission to send the control instruction.

7. The method according to claim 1, wherein the determining, by the first device, whether the second device has permission to send the control instruction comprises:
obtaining, by the first device, position information of the second device;
determining, by the first device, whether the position information of the second device meets permission possessed by the second device; and
if yes, determining, by the first device, that the second device has the permission to send the control instruction.

8. A device, comprising:
a receiving module configured to receive a control instruction from a second device;
a determining module configured to determine whether the second device has permission to send the control instruction, and send a determining result to a sending module; and
the sending module configured to: when the determining result is that the second device has the permission to send the control instruction, send the control instruction to an aerial vehicle to control the aerial vehicle to perform an operation corresponding to the control instruction.

9. The device according to claim 8, wherein the receiving module is further configured to:
receive a control request from the second device, the control request being used for requesting to control the aerial vehicle; and
the device further comprises:
an assigning module configured to assign, to the second device according to the control request, permission to control the aerial vehicle.

10. The device according to claim 8, further comprising:
an assigning module configured to assign, to at least one device connected to the first device, permission to control the aerial vehicle.

11. The device according to claim 10, wherein the sending module is further configured to:
send information about the assigned permission to a corresponding device.

12. The device according to claim 8, wherein the determining module is specifically configured to implement the determining whether the second device has permission to send the control instruction in the following manner:
determining a control function corresponding to the control instruction;
determining whether the second device has permission corresponding to the control function; and
if yes, determining that the second device has the permission to send the control instruction.

13. The device according to claim 8, wherein the determining module is specifically configured to implement the determining whether the second device has permission to send the control instruction in the following manner:
determining a time at which the second device sends the control instruction;
determining whether the sending time meets permission possessed by the second device; and
if yes, determining that the second device has the permission to send the control instruction.

14. The device according to claim 8, wherein the determining module is specifically configured to implement the determining whether the second device has permission to send the control instruction in the following manner:
obtaining position information of the second device;
determining whether the position information of the second device meets permission possessed by the second device; and
if yes, determining that the second device has the permission to send the control instruction.

15. A device, comprising a processor and a computer readable storage medium, wherein the computer readable storage medium stores a computer instruction, and the processor is configured to invoke the computer instruction to perform the aerial vehicle control method comprising:
receiving, by a first device, a control instruction from a second device;
determining, by the first device, whether the second device has permission to send the control instruction; and
if yes, sending, by the first device, the control instruction to an aerial vehicle to control the aerial vehicle to perform an operation corresponding to the control instruction.
